(19) United States
(12) Patent Application Publication
(10) Pub. No.: US 2023/0250226 A1
(43) Pub. Date: Aug. 10, 2023

(54) THERMOPLASTIC POLYESTER FOR PRODUCING 3D-PRINTED OBJECTS

(71) Applicant: ROQUETTE FRERES, Lestrem (FR)

(72) Inventors: Hélène AMEDRO, Bethune (FR); René SAINT-LOUP, Lomme (FR)

(21) Appl. No.: 18/004,817

(22) PCT Filed: Jun. 29, 2021
(86) PCT No.: PCT/EP2021/025240

§ 371 Date: Jan. 9, 2023

(30) Foreign Application Priority Data
Jul. 10, 2020 (FR) 2007343

(51) Int. Cl. C08G 63/672; B33Y 70/00; B33Y 10/00; B29C 64/118; B29C 64/314

(52) U.S. Cl. CPC C08G 63/672; B33Y 70/00; B33Y 10/00; B29C 64/118; B29C 64/314; B29K 2067/00

(57) ABSTRACT

The invention relates to the use of a thermoplastic polyester for producing a 3D-printed object, said polyester comprising: at least one 1.4:3.6-dianhydrohexitol unit (A), at least one ethylene glycol unit (B); at least one terephthalic acid unit (C), wherein the ratio (A)/[(A)+(B)] is at least 0.01 and at most 0.60, said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g.

### TECHNICAL FIELD

The present invention relates to the field of 3D printing and is directed especially to the use of a thermoplastic polyester for producing a 3D-printed object, said thermoplastic polyester having particularly interesting properties for this application.

### BACKGROUND ART

The field of 3D printing has been growing quickly in recent years. It is now possible to produce 3D-printed objects in a multitude of materials such as for example plastic, wax, metal, plaster of Paris and even ceramics.

Despite this variety of usable materials, the choice of available compounds within each material is sometimes limited.

As regards 3D-printed objects produced using plastic materials, only a few polymers can be used, in particular for the filament spools used in certain 3D-printing techniques.

At the present time, polymers such as ABS (acrylonitrile-butadiene-styrene) and PLA (polylactic acid) are the main players alongside polyamides and photo-resins or photo-polymers.

ABS is an amorphous polymer, the Tg of which varies from 100 to 115° C. according to its composition and has several limitations in its shaping. Indeed, its use requires relatively high process temperatures of 220 to 240° C., but above all a bed temperature of 80° C. to 110° C., which requires particularly suitable instrumentation. In addition, for obtaining solid objects, the use of ABS causes, in all cases, visible runs and cracks on the final object due to a very pronounced shrinkage.

PLA, alone or optionally mixed generally with polyhydroxyalkanoates, is less demanding in terms of the required temperatures and one of its main features lies in its low shrinkage during 3D printing, which is why the use of a heating plate is not necessary during 3D printing by the FDM (Fused Deposition Modeling) technique. However, its main limitation lies in a low glass transition temperature of the mixture that is of the order of 60° C.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units.

In the case where SLS (Selective Laser Sintering) technology is used, the number of available polymers is also very small. The most suitable polymers are semi-crystalline since the sintering results from a melting/recrystallization process and makes it possible to obtain very good cohesion of the material. The polyamides (PA12, PA11) and some materials such as thermoplastic polyurethanes (TPU), polyetherketone (PEK), polyetheretherketone (PEEK), and polyether block amide (PEBA) are most commonly found.

### TECHNICAL PROBLEM

However, for certain applications or under certain usage conditions, it is necessary to improve some properties, and especially the impact resistance or else the heat resistance. Thus, glycol-modified PETs (PETg) have been developed. These are generally polyesters comprising, in addition to ethylene glycol and terephthalic acid units, cyclohexanedimethanol (CHDM) units. The introduction of this CHDM diol into the PET makes it possible for it to adapt the properties to the intended application, for example to improve its impact resistance or its optical properties, especially when the PETg is amorphous.

Other modified PETs have also been developed by introducing, into the polyester, 1.4: 3.6-dianhydrohexitol units, especially isosorbide (PEIT). These modified polyesters have higher glass transition temperatures than unmodified PETs or PETgs comprising CHDM. In addition, 1.4: 3.6-dianhydrohexitols have the advantage of being able to be obtained from renewable resources such as starch.

In order to improve the impact resistance properties of the polyesters, it is known from the prior art to use polyesters, the crystallinity of which has been reduced. The aim is to therefore obtain polymers in which the crystallinity is removed by adding comonomers, and hence in this case by adding 1.4-cyclohexanedimethanol.

Regarding isosorbide-based polyesters, mention may be made of application US2012/0177854, which discloses polyesters comprising terephthalic acid units and diol units comprising from 1 to 60 mol % of isosorbide and from 5 to 99% of 1.4-cyclohexanedimethanol which have improved impact resistance properties.

The use of copolyesters with improved thermal properties and necessarily comprising an alicyclic diol, such as CHDM, isosorbide and terephthalic acid for 3D-printing applications has been disclosed in application WO2018020192. Such a copolyester is free of ethylene glycol or contains a residual amount thereof.

Application WO 2018212596 discloses a mixture of polyesters used for producing a 3D-printed filament. This mixture consists of a polyester A containing at least isosorbide and terephthalic acid and a polyester B containing terephthalic acid and a diol other than isosorbide. The production of a 3D object with such a mixture would involve additional steps of homogenizing the two polyesters.

Therefore, thanks to the applicant, it has been found that this need for alternative plastic raw materials for use in 3D printing could be met, against all expectations, with a thermoplastic polyester based on 1.4:3.6-dianhydrohexitol, in particular isosorbide, having none or very few alicyclic diol units, in particular CHDM, while it was known until now that the latter was essential for obtaining polymers whose crystallinity is reduced, or even removed, and which have good thermal and optical properties.

### SUMMARY OF THE INVENTION

Thus, an object of the invention is the use of a thermoplastic polyester for producing a 3D-printed object, said polyester comprising:
at least one 1.4:3.6-dianhydrohexitol unit (A);
at least one ethylene glycol unit (B);
at least one terephthalic acid unit (C); wherein the molar ratio (A)/[(A)+(B)] is at least 0.01 and at most 0.60; said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g.

A second object of the invention relates to a 3D-printed object comprising the previously disclosed thermoplastic polyester.

Finally, a third object relates to a method for producing 3D-printed objects from the thermoplastic polyester disclosed above, said production method comprising the following steps of:
Providing a thermoplastic polyester comprising at least one 1.4:3.6-dianhydrohexitol unit (A), at least one ethylene glycol unit (B) other than the 1.4:3.6-dianhydrohexitol units (A), at least one terephthalic acid unit (C), wherein the molar ratio (A)/[(A)+(B)] is at least 0.01 and at most 0.60, said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g,
Shaping the thermoplastic polyester obtained in the preceding step,
3D printing an object from the shaped thermoplastic polyester,
Recovering the 3D-printed object.

The thermoplastic polyesters used according to the present invention offer excellent properties and make it possible to produce 3D-printed objects.

The polymer composition integrating such a thermoplastic polyester is particularly advantageous and has improved properties. Indeed, the presence of thermoplastic polyester in the composition contributes additional properties and broadens the fields of application of other polymers.

The thermoplastic polyester according to the invention thus has very good properties, in particular optical and thermal properties, and is particularly suitable for use in the production of 3D-printed objects, without this production being limited by the 3D printing method used.

### DISCLOSURE OF THE INVENTION

A first object of the invention thus relates to the use of a thermoplastic polyester for producing a 3D-printed object, said polyester comprising:
at least one 1.4:3.6-dianhydrohexitol unit (A);
at least one ethylene glycol unit (B);
at least one terephthalic acid unit (C);
wherein the molar ratio (A)/[(A)+(B)] is at least 0.01 and at most 0.60; said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g.

“(A)/[(A)+(B)] molar ratio” is intended to mean the molar ratio of 1.4: 3.6-dianhydrohexitol units (A)/sum of the 1.4: 3.6-dianhydrohexitol units (A) and the ethylene glycol diol units (B).

The thermoplastic polyester is free of alicyclic diol units or comprises a small amount thereof.

“Small molar amount of alicyclic diol units” is intended to mean, especially, a molar amount of alicyclic diol units of less than 5%. According to the invention, this molar amount represents the ratio of the sum of the alicyclic diol units, units which can be identical or different, relative to the total of monomeric units in the polyester.

The alicyclic diol is also referred to as aliphatic and cyclic diol. The alicyclic diol is very preferentially 1.4-cyclohexanedimethanol. The alicyclic diol (B) may be in the cis configuration, in the trans configuration, or may be a mixture of diols in the cis and trans configurations.

The polyester can be free of alicyclic diol units or comprises a molar amount of alicyclic diol units, relative to the total of monomeric units in the polyester, of less than 1%; preferably, the polyester is free of alicyclic diol units.

Thus, the molar amount of alicyclic diol unit which may be chosen from 1.4-cyclohexanedimethanol, 1.2-cyclohexanedimethanol, 1.3-cyclohexanedimethanol or a mixture thereof is advantageously less than 1%. Preferably, the polyester is free of alicyclic diol units which may be chosen from 1.4-cyclohexanedimethanol, 1.2-cyclohexanedimethanol, 1.3-cyclohexanedimethanol or a mixture thereof. More preferentially, it is free of 1.4-cyclohexanedimethanol.

Despite the small amount, or even the absence, of alicyclic diol, and therefore of 1.4-cyclohexanedimethanol, used for the synthesis, a thermoplastic polyester is surprisingly obtained which has a high reduced viscosity in solution and wherein the amount of isosorbide incorporated can be controlled. Thus, depending on the isosorbide incorporation rate, it is possible to obtain amorphous or semi-crystalline copolyesters and broaden the range of properties accessible to the 3D-printed objects obtained through different production methods, whether by filamentary printing or by SLS.

The monomer (A) is a 1.4: 3.6-dianhydrohexitol may be isosorbide, isomannide, isoidide, or a mixture thereof. Preferably, the 1.4: 3.6-dianhydrohexitol (A) is isosorbide.

Isosorbide, isomannide and isoidide can be obtained, respectively, by dehydration of sorbitol, mannitol and iditol. Regarding isosorbide, it is sold by the Applicant under the trade name POLYSORB®.

25

The molar ratio of 1.4: 3.6-dianhydrohexitol units (A)/sum of the 1.4: 3.6-dianhydrohexitol units (A) and the ethylene glycol diol units (B), i.e. (A)/[(A)+(B)] is at least 0.01 and at most 0.60. When the molar ratio (A)/[(A)+(B)] is less than 0.15, the thermoplastic polyester is semi-crystalline and is characterized by the presence of a crystalline phase resulting in the presence of X-ray diffraction lines and the presence of an endothermic melting peak in differential scanning calorimetric (DSC) analysis.

Conversely, when the molar ratio (A)/[(A)+(B)] is greater than 0.15, the thermoplastic polyester is amorphous and is characterized by an absence of X-ray diffraction lines and by an absence of an endothermic melting peak in differential scanning calorimetric (DSC) analysis.

A thermoplastic polyester particularly suited for producing a 3D-printed object comprises:
a molar amount of 1.4:3.6-dianhydrohexitol units (A) ranging from 0.5 to 33 mol %;
a molar amount of ethylene glycol units (B) ranging from 18 to 54.5 mol %;
a molar amount of terephthalic acid units (C) ranging from 45 to 55 mol %.

Depending on the sought applications and properties regarding the 3D-printed object, the thermoplastic polyester can be a semi-crystalline thermoplastic polyester or an amorphous thermoplastic polyester.

For example, if for certain applications it is sought to obtain an object that can be opaque and have improved mechanical properties, the thermoplastic polyester can be semi-crystalline and thus comprises:
a molar amount of 1.4:3.6-dianhydrohexitol units (A) ranging from 0.5 to 8.5 mol %;
a molar amount of ethylene glycol units (B) ranging from 38 to 54.5 mol %;
a molar amount of terephthalic acid units (C) ranging from 45 to 55 mol %.

Advantageously, when the thermoplastic polyester is semi-crystalline, it has a molar ratio (A)/[(A)+(B)] of 0.01 to 0.15.

Conversely, when the object is sought to be transparent, the thermoplastic polyester can be amorphous and thus comprises:
a molar amount of 1.4:3.6-dianhydrohexitol units (A) ranging from 7 to 33 mol %;
a molar amount of ethylene glycol units ranging from 18 to 46.5 mol %;
a molar amount of terephthalic acid units (C) ranging from 45 to 55 mol %.

Advantageously, when the thermoplastic polyester is amorphous, it has a molar ratio (A)/[(A)+(B)] of 0.16 to 0.60.

Those skilled in the art can readily find the analysis conditions for determining the amounts of each of the units of the thermoplastic polyester. For example, from an NMR spectrum of a poly(ethylene-co-isosorbide terephthalate), the chemical shifts relating to the ethylene glycol are around 4.8 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

Thermoplastic polyesters have a glass transition temperature ranging from 75 to 140° C., for example from 75 to 95° C. if they are semi-crystalline and for example from 95° C. to 140° C. if they are amorphous.

The glass transition temperatures and melting points are measured by conventional methods, especially using differential scanning calorimetry (DSC) using a heating rate of 10° C./min. The experimental protocol is described in detail in the examples section below.

The thermoplastic polyesters used according to the invention, when they are semi-crystalline, have a melting point ranging from 205 to 250° C., for example from 215 to 245° C.

Advantageously, when the thermoplastic polyester is semi-crystalline, it has a heat of fusion greater than 20 J/g, preferably greater than 25 J/g, the measurement of this heat of fusion consisting of subjecting a sample of this polyester to a heat treatment at 170° C. for 16 hours and then evaluating the heat of fusion by DSC by heating the sample at 10° C./min.

The thermoplastic polyester of the polymer composition according to the invention especially has a lightness L* greater than 45. Advantageously, the lightness L* is greater than 50, preferably greater than 55, most preferentially greater than 60, for example greater than 62. The parameter L* may be determined using a spectrophotometer, via the CIE Lab model.

Finally, the reduced viscosity in solution of said thermoplastic polyester used according to the invention is greater than 40 mL/g and preferably less than 150 mL/g, this viscosity being able to be measured using an Ubbelohde capillary viscometer at 35° C. in orthochlorophenol after dissolving the polymer at 130° C. with stirring, the concentration of polymer introduced being 5 g/L.

This test for measuring reduced viscosity in solution is, due to the choice of solvents and the concentration of the polymers used, perfectly suited for determining the viscosity of the viscous polymer prepared according to the process described below.

Advantageously, when the thermoplastic polyester is semi-crystalline, it has a reduced viscosity in solution greater than 40 mL/g and less than 120 mL/g and when the thermoplastic polyester is amorphous, it has a reduced viscosity in solution of 50 to 90 mL/g.

The semi-crystalline or amorphous nature of the thermoplastic polyesters used according to the present invention is characterized, after a heat treatment for 16 h at 170° C., by the optional presence of X-ray diffraction lines or an endothermic melting peak in differential scanning calorimetric (DSC) analysis. Thus, when there is a presence of X-ray diffraction lines and an endothermic melting peak in differential scanning calorimetric (DSC) analysis, the thermoplastic polyester is semi-crystalline; otherwise, it is amorphous.

According to a particular embodiment, one or more additional polymers can be used in a mixture with the thermoplastic polyester for producing a 3D-printed object.

The additional polymer may be selected from polyamides, photo-resins, photo-polymers, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2.6-dimethylphenylene oxide), poly(phenylene sulfate)s, poly(ester-carbonate)s, polycarbonates, polysulfones, polysulfone ethers, polyether ketones, and mixtures of these polymers.

The additional polymer may also be a polymer which makes it possible to improve the impact properties of the polyester, especially functional polyolefins such as functionalized ethylene or propylene polymers and copolymers, core-shell copolymers or block copolymers.

In particular, the 3D-printed object comprises a polymeric mixture consisting of said thermoplastic polyester and one or more additional polymers, said mixture comprising at least 30% by weight of thermoplastic polyester with respect to the total weight of said mixture, preferably said one or more additional polymers being selected from polyesters, such as polybutylene terephthalate (PBT), polylactic acid (PLA), polybutylene succinate (PBS), polybutylene succinate adipate (PBSA), polyethylene terephthalate PET, glycolated polyethylene terephthalate (PETg), polycarbonates (PC), polyamides (PA), acrylonitrile butadiene styrene (ABS), thermoplastic polyurethanes (TPU), polyetheretherketone (PEEK), polyacrylates.

When an additional polymer is used, the latter can for example be added when shaping the thermoplastic polyester for 3D printing or when preparing the thermoplastic polyester.

One or more additives can also be added to the thermoplastic polyester during the production of the 3D-printed object in order to grant it particular properties.

Thus, by way of example of additives, mention may be made of fillers or organic or inorganic fibers, whether on the nanometer scale or not, functionalized or not. These may be silicas, zeolites, glass beads or fibers, clays, mica, titanates, silicates, graphite, calcium carbonate, carbon nanotubes, wood fibers, carbon fibers, polymer fibers, proteins, cellulose fibers, lignocellulosic fibers, and non-destructured granular starch. These fillers or fibers may make it possible to improve the hardness, rigidity or surface appearance of the printed parts.

The additive may also be selected from opacifiers, dyes and pigments. They may be selected from cobalt acetate and the following compounds: HS-325 Sandoplast® RED BB (which is a compound bearing an azo function, also known under the name of Solvent Red 195), HS-510 Sandoplast® Blue 2B, which is an anthraquinone, Polysynthren® Blue R, and Clariant® RSB Violet.

The additive may also be a UV-resistance agent such as, for example, benzophenone or benzotriazole-type molecules, such as the Tinuvin™ range from BASF: Tinuvin 326, Tinuvin P or Tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example Melapur™: Melapur 200), or else aluminum or magnesium hydroxides.

Finally, the additive may also be an antistatic agent or else an antiblocking agent such as derivatives of hydrophobic molecules, for example Incroslip™ or Incromol™ from Croda.

The thermoplastic polyester according to the invention is thus used for producing a 3D-printed object.

The 3D-printed object can be produced using 3D printing techniques known to a skilled person.

example, 3D printing can be implemented by fused deposition modeling (FDM) or by selective laser sintering. Preferentially, 3D printing is carried out by fused deposition modeling.

3D printing by fused deposition modeling particularly consists of extruding a thread of thermoplastic polymer material onto a platform through a nozzle moving on the three axes x, y and z. The platform descends by one level with each new layer applied, until the object is finished being printed.

The skilled person can thus easily adapt the shaping of the thermoplastic polyester according to the invention so that the latter can be used according to any one of the 3D printing methods.

The thermoplastic polyester can be in the form of a thread, filament, rod, granules, pellets or powder. For example, for 3D printing by fused deposition modeling, the thermoplastic polyester can be in the form of a rod or thread, preferably in the form of a thread, before being cooled and then spooled. The spool of thread thus obtained can thus be used in a 3D printing machine for the production of objects. In another example, for 3D printing by selective laser sintering, the thermoplastic polyester may be in powder form.

Preferentially, when the object according to the invention is produced by 3D printing by fused deposition modeling, the characteristics used for 3D printing can be optimized depending on whether the thermoplastic polyester is semi-crystalline or amorphous.

Thus, during 3D printing by fused deposition modeling, when the thermoplastic polyester is semi-crystalline, the temperature of the printing nozzle is preferentially between 250° C. and 275° C. and the bed has a temperature of 40° C. to 75° C. When the thermoplastic polyester is amorphous, the temperature of the printing nozzle is preferentially from 200° C. to 220° C. and the bed may or may not be heated with a temperature up to a maximum of 60° C.

According to a particular embodiment, when the object is produced by 3D printing by fused deposition modeling from a semi-crystalline thermoplastic polyester, said object can be recrystallized in order to make it opaque and to improve the mechanical properties, in particular the impact resistance. The recrystallization may be carried out at a temperature of 130° C. to 190° C., preferably from 140° C. to 180° C., such as, for example, 160° C., for a period of time of 3 h to 5 h, preferentially from 3:30 h to 4:30 h, such as for example 4 h.

The thermoplastic polyester as previously defined has many advantages for producing a 3D-printed object.

Indeed, by virtue especially of the molar ratio of 1.4: 3.6-dianhydrohexitol units (A)/sum of the 1.4: 3.6-dianhydrohexitol units (A) and ethylene glycol units (B) of at least 0.01 and at a reduced viscosity in solution greater than 40 mL/g and preferably less than 120 mL/g, the thermoplastic polyesters make it possible to obtain 3D-printed objects which do not creep, which do not crack and which exhibit good mechanical properties, in particular at the impact strength.

More particularly, when the thermoplastic polyester is an amorphous thermoplastic polyester, it has a higher glass transition temperature than the polymers conventionally used for producing 3D-printed objects, which makes it possible to improve the thermal resistance of the objects obtained.

Then, when the thermoplastic polyester used for producing 3D-printed objects is a semi-crystalline thermoplastic polyester, the 3D-printed object has enough crystals to be solid and stable. The semi-crystalline thermoplastic polyester then advantageously has, via recrystallization by subsequent heating, the possibility of increasing its degree of crystallinity, which makes it possible to improve its mechanical properties, including its impact strength.

Finally, the thermoplastic polyesters according to the invention are advantageous because they make it possible, when mixed with the usual polymers used for the production of 3D-printed objects, such as a polyamide, a photo-resin or a photo-polymer, to broaden the range of properties accessible to 3D-printed objects.

A second object of the invention relates to a method for producing a 3D-printed object, said method comprising the following steps of:
a) Providing a thermoplastic polyester as defined above,
b) Shaping the thermoplastic polyester obtained in the preceding step,
c) 3D printing an object from the shaped thermoplastic polyester,
d) Recovering the 3D-printed object.

The shaping of step b) is adapted by a skilled person depending on the 3D printing method implemented in step c).

The thermoplastic polyester can thus be placed in the form of a thread, filament, rod, granules, pellets or powder. For example, if the 3D printing is carried out by fused deposition modeling, the shaping is advantageously a thread and in particular a spooled thread. The spool of thread can be obtained from an extrusion of the thermoplastic polyester in the form of a thread, said thread then being cooled and spooled.

The 3D printing can be carried out using techniques known to a skilled person. For example, the 3D printing step can be carried out by fused deposition modeling or by selective laser sintering.

According to one alternative, when the polyester provided is a semi-crystalline thermoplastic polyester, the method according to the invention may further comprise an additional step e) of recrystallization. This recrystallization step makes it especially possible to make the 3D-printed object opaque and to improve its mechanical properties such as the impact resistance. The recrystallization step can be carried out at a temperature of 130° C. to 190° C., preferably from 140° C. to 180° C., such as, for example, 160° C., for a period of time of 3 h to 5 h, preferably from 3:30 h to 4:30 h, such as for example 4 h

A third object of the invention relates to a 3D-printed object produced using the previously disclosed thermoplastic polyester. The 3D-printed object may also comprise one or more additional polymers as well as one or more additives.

The thermoplastic polyester that is particularly suitable for obtaining a polymer composition can be prepared by a synthesis method comprising:
a step of introducing, into a reactor, monomers comprising at least one 1.4:3.6-dianhydrohexitol (A), at least one ethylene glycol (B) and at least one terephthalic acid (C), the molar ratio ((A)+(B))/(C) ranging from 1.05 to 1.5, said monomers being free of alicyclic diol or comprising, relative to the total of monomers introduced, a molar amount of alicyclic diol units of less than 5%;
a step of introducing a catalytic system into the reactor;
a step of polymerizing said monomers to form the polyester, said step consisting of:
a first stage of oligomerization, during which the reaction medium is stirred under an inert atmosphere at a temperature ranging from 235 to 280° C., advantageously from 240 to 270° C., for example 250° C.;
a second stage of condensation of the oligomers, during which the oligomers formed are stirred under vacuum, at a temperature ranging from 238 to 290° C. so as to form the polyester, advantageously from 250 to 270° C., for example 265° C.;
a step of recovering the thermoplastic polyester.

When the polymer is semi-crystalline, the method may further comprise:
optionally, a step of solid-state post-condensation,
a step of crystallizing the polymer under an inert atmosphere, preferably between 120 and 190° C.,
a step of solid-state post-condensation under vacuum or an inert gas flow, preferably between 180 and 240° C.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 1.05 to 6 bar, most preferentially from 1.5 to 5 bar, for example 2.5 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum and then by introducing an inert gas such as nitrogen. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease gradients, in steps, or else using a combination of pressure decrease gradients and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process further comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer for obtaining the polymer composition.

An esterification catalyst is advantageously used during the oligomerization stage. This esterification catalyst can be chosen from derivatives of tin, titanium, zirconium, hafnium, zinc, manganese, calcium, strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step may be optionally blocked by adding phosphorous acid or phosphoric acid, or else, as in the case of tin (IV), reduced with phosphites such as triphenyl phosphite or tris(nonylphenyl) phosphites or those cited in paragraph [0034] of application US2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1882712 B1 in paragraphs [0090] to [0094].

Preferably, the catalyst is a derivative of tin, titanium, germanium, aluminum or antimony.

By way of example of amounts by weight, use may be made of from 10 to 500 ppm of metal contained in the catalytic system during the oligomer condensation stage, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of from 10 to 500 ppm of metal contained in the catalytic system, relative to the amount of monomers introduced.

According to the preparation process, use is advantageously made of an antioxidant during the step of polymerization of the monomers. These antioxidants make it possible to reduce the coloration of the polyester obtained. The antioxidants can be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or

Irganox® 1076 or a phosphonate such as Irgamod® 195. The secondary antioxidant may be trivalent phosphorus-based compounds such as Ultranox® 626, Doverphos® S-9228, Hostanox® P-EPQ or Irgafos 168.

It is also possible to introduce, as polymerization additive into the reactor, at least one compound that is capable of limiting unwanted etherification reactions, such as sodium acetate, tetramethylammonium hydroxide or tetraethylammonium hydroxide.

Finally, the process comprises a step of recovering the polyester at the end of the polymerization step. The thermoplastic polyester thus recovered may then be packed in a form that is easy to handle, such as pellets or granules before being reshaped for the needs of 3D printing.

According to a variant of the synthesis process, when the thermoplastic polyester is semi-crystalline, a step of increasing the molar mass can be carried out after the step of recovering the thermoplastic polyester.

The step of increasing the molar mass is carried out by post-polymerization and may consist of a step of solid-state polycondensation (SSP) of the semi-crystalline thermoplastic polyester or of a step of reactive extrusion of the semi-crystalline thermoplastic polyester in the presence of at least one chain extender.

Thus, according to a first variant of the production process, the post-polymerization step is carried out by SSP.

SSP is generally carried out at a temperature between the glass transition temperature and the melting point of the polymer. Thus, in order to carry out the SSP, it is necessary for the polymer to be semi-crystalline. Preferably, the latter has a heat of fusion of greater than 20 J/g, preferably greater than 25 J/g, the measurement of this heat of fusion consisting in subjecting a sample of this polymer of lower reduced viscosity in solution to a heat treatment at 170° C. for 16 hours, then in evaluating the heat of fusion by DSC by heating the sample at 10 K/min.

Advantageously, the SSP step is carried out at a temperature ranging from 180 to 250° C., preferably ranging from 190 to 230° C., this step imperatively having to be carried out at a temperature below the melting point of the semi-crystalline thermoplastic polyester.

The SSP step may be carried out in an inert atmosphere, for example under nitrogen or under argon or under vacuum.

According to a second variant of the production process, the post-polymerization step is carried out by reactive extrusion of the semi-crystalline thermoplastic polyester in the presence of at least one chain extender.

The chain extender is a compound comprising two functions capable of reacting, in reactive extrusion, with functions, with alcohol, carboxylic acid and/or carboxylic acid ester functions of the semi-crystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in all of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semi-crystalline thermoplastic polyester obtained in the extrusion step.

During the extrusion, the temperature inside the extruder is adjusted so as to be above the melting point of the polymer. The temperature inside the extruder may range from 150 to 320° C.

The semi-crystalline thermoplastic polyester obtained after the step of increasing the molar mass is recovered and can then be packed in a form that is easy to handle, such as pellets or granules before being reshaped for the needs of 3D printing.

The invention will be understood more clearly by means of the examples and figures below, which are intended to be purely illustrative and do not in any way limit the scope of protection.

### EXAMPLES

The properties of the polymers were studied with the following techniques:

Reduced Viscosity in Solution

The reduced viscosity in solution is assessed using an Ubbelohde capillary viscometer at 35° C. in orthochlorophenol after dissolving the polymer at 130° C. under stirring, the concentration of polymer introduced being 5 g/L.

DSC

The thermal properties of the polyesters were measured by differential scanning calorimetry (DSC): The sample is first heated under a nitrogen atmosphere in an open crucible from 10 to 300° C. (10° C.min-1), cooled to 10° C. (10° C.min-1), then heated again to 300° C. under the same conditions as the first step. The glass transition temperatures were taken at the mid-point of the second heating. Any melting points are determined on the endothermic peak (peak onset) at the first heating.

Similarly, the enthalpy of fusion (area under the curve) is determined at the first heating.

For the illustrative examples presented below, the following reagents were used:

Ethylene glycol, Aldrich

Isosorbide (purity >99.5%) Polysorb® P from Roquette Freres

Terephthalic acid (purity 99+%) from Acros

Sodium acetate tetrahydrate, Aldrich

Irgamod® 195 from BASF AG (calcium phosphonate)

Germanium dioxide, Aldrich

### Example 1

### Use of an Amorphous Thermoplastic Polyester for Producing a 3D-Printed Object

An amorphous thermoplastic polyester P1 is prepared for use according to the invention in 3D printing.

A: Polymerization

893 g (14.4 mol) ethylene glycol, 701 g (4.8 mol) isosorbide, 2656 g (16 mol) terephthalic acid, 0.7070 g Irgamod 195 (antioxidant), 0.1825 g sodium acetate tetrahydrate, and 0.9820 g germanium dioxide (catalyst) are added to a 7 L reactor. To extract the residual oxygen from the isosorbide crystals, four vacuum-nitrogen cycles are performed once the temperature of the reaction medium is between 60 and 80° C.

The reaction mixture is then heated to 250° C. (4° C/min) under 2.5 bar of pressure and under constant stirring (150 rpm). The degree of esterification is estimated based on the amount of distillate collected. The pressure is then reduced to 0.7 mbar over 90 minutes according to a logarithmic gradient and the temperature is brought to 265° C.

These low-pressure and temperature conditions were maintained until an increase in torque of 21 Nm with respect to the initial torque was obtained.

Finally, a polymer rod is cast via the bottom valve of the reactor, cooled in a heat-regulated water bath at 15° C. and chopped up in the form of granules G1 of about 15 mg.

Using such a method makes it possible to avoid contact between the heated polymer and oxygen, so as to reduce the coloration and the thermo-oxidative degradation.

The resin thus obtained has a reduced viscosity in solution of 63 mL/g.

¹H NMR analysis of the polyester P1 shows that it contains 31.4% mol % of isosorbide with respect to the diols.

With regard to the thermal properties (measured during the second heating), the polyester P1 has a glass transition temperature of 112° C.

B: Extrusion of the Granules to Form a Rod

The granules G1 obtained in the previous step are dried under vacuum at 80° C. in order to achieve residual moisture levels of less than 150 ppm. For this example, the water content of the granules is 109 ppm.

The extrusion of the rod/thread is carried out on a Collin extruder equipped with a die having two holes with a diameter of 2 mm each, the assembly is completed by a cooled shaper and a water cooling bath.

The extrusion parameters are grouped together in Table 1 below:

TABLE 1

| Parameters | Units | Values |
|---|---|---|
| Temperature (supply −> | ° C. | 210/220/230/220/215 |
| die): | | |
| Screw rotation speed | rpm | 75 |

At the outlet of the extruder, the thread obtained has a diameter of 1.75 mm. It is then surface-dried after cooling by a flow of hot air at 60° C. and then spooled.

C: Shaping of a 3D-Printed Object by Fused Deposition Modeling

The spool is installed on a Stream 20 Pro 3D printer from the company Volumic.

The temperature of the nozzle is set at 210° C. and the bed is heated to 55° C.

The printed object obtained is a 3D polyhedron formed by several planar pentahedrons connected together by the edges.

A visual observation reveals that the produced object does not have any creep or any cracks. In addition, the object obtained is transparent and also has a good surface finish.

Thus, the amorphous thermoplastic polyester according to the invention is particularly suitable for producing a printed object.

### Example 2

### Use of a Semi-Crystalline Thermoplastic Polyester for Producing a 3D-Printed Object

A semi-crystalline thermoplastic polyester P2 is prepared for use according to the invention in 3D printing.

A: Polymerization

1004 g (16.2 mol) ethylene glycol, 322 g (2.2 mol) isosorbide, 2656 g (16 mol) terephthalic acid, 0.7070 g Irgamod 195 (antioxidant), 0.1825 g sodium acetate tetrahydrate, and 0.9820 g germanium dioxide (catalyst) are added to a 7 L reactor. To extract the residual oxygen from the isosorbide crystals, four vacuum-nitrogen cycles are performed once the temperature of the reaction medium is 60° C.

The reaction mixture is then heated to 250° C. (4° C./min) under 2.5 bar of pressure and under constant stirring (150 rpm). The degree of esterification is estimated based on the amount of distillate collected. The pressure is then reduced to 0.7 mbar over 90 minutes according to a logarithmic gradient and the temperature is brought to 265° C.

These low-pressure and temperature conditions were maintained until an increase in torque of 13 Nm with respect to the initial torque was obtained.

Finally, a polymer rod is cast via the bottom valve of the reactor, cooled in a heat-regulated water bath at 15° C. and chopped up in the form of granules G2 of about 15 mg.

Using such a method makes it possible to avoid contact between the heated polymer and oxygen, so as to reduce the coloration and the thermo-oxidative degradation.

The resin thus obtained has a reduced viscosity in solution of 57 mL/g.

¹H NMR analysis of the polyester P2 shows that it contains 10.2 mol % of isosorbide with respect to the diols.

The granules thus obtained are subjected to a solid-state post-condensation treatment following the following protocol: 2.8 kg of granules of the previous polymer are introduced into a 50 L rotary evaporator. The oil of the bath is then rapidly brought to 120° C. and is then gradually heated to 145° C. until optimum crystallization of the granules is obtained. This step is carried out under a flow of nitrogen at a rate of 3.3 L/min. The flask is then heated to 220° C. under a nitrogen flow of 3.3 L/min until an IV of 88 mL/g is obtained.

With regard to the thermal properties, the polymer P2 has a glass transition temperature of 91° C., and a melting point of 222° C. with an enthalpy of fusion of 36 J/g.

B: Extrusion of the Granules to Form a Rod

The granules G2 obtained in the previous step are dried under vacuum at 80° C. in order to achieve residual moisture levels of less than 100 ppm. For this example, the water content of the granules is 78 ppm.

The extrusion of the rod/thread is carried out on a Collin extruder equipped with a die having two holes with a diameter of 2 mm each, the assembly is completed by a cooled shaper and a water cooling bath.

The extrusion parameters are grouped together in Table 1 below:

TABLE 1

| Parameters | Units | Values |
|---|---|---|
| Temperature (supply −> | ° C. | 240/250/260/250/245 |
| die): | | |
| Screw rotation speed | rpm | 75 |

At the outlet of the extruder, the thread obtained has a diameter of 1.75 mm. It is then surface-dried after cooling by a flow of hot air at 60° C. and then spooled.

C: Shaping of a 3D-Printed Object by Fused Deposition Modeling

The spool is installed on a Stream 20 Pro 3D printer from the company Volumic.

The temperature of the nozzle is set at 240° C. and the bed is heated to 75° C.

The printed object obtained is a 3D polyhedron formed by several planar pentahedrons connected together by the edges.

A visual observation reveals that the produced object does not have any creep or any cracks. In addition, the object obtained is transparent and also has a good surface finish.

Thus, the semi-crystalline thermoplastic polyester according to the invention is particularly suitable for producing a printed object.

1. A use of a thermoplastic polyester for producing a 3D-printed object, said polyester comprising:
at least one 1.4:3.6-dianhydrohexitol unit (A);
at least one ethylene glycol unit (B);
at least one terephthalic acid unit (C);
wherein the ratio (A)/[(A)+(B)] is at least 0.01 and at most 0.60;
said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g.

2. A 3D-printed object comprising a thermoplastic polyester comprising:
at least one 1.4:3.6-dianhydrohexitol unit (A);
at least one ethylene glycol unit (B);
at least one terephthalic acid unit (C);
wherein the ratio (A)/[(A)+(B)] is at least 0.01 and at most 0.60;
said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g.

3. A method for producing a 3D-printed object comprising the following steps of:
a) Providing a thermoplastic polyester comprising at least one 1.4:3.6-dianhydrohexitol unit (A), at least one ethylene glycol unit (B) other than the 1.4:3.6-dianhydrohexitol units (A), at least one terephthalic acid unit (C), wherein the ratio (A)/[(A)+(B)] is at least 0.01 and at most 0.60, said polyester being free of alicyclic diol units or comprising a molar amount of alicyclic diol units, relative to the total of monomeric units in the polyester, of less than 5%, and having a reduced viscosity in solution (35° C.; orthochlorophenol; 5 g/L polyester) greater than 40 mL/g,
b) Shaping the thermoplastic polyester obtained in the preceding step,
c) 3D printing an object from the shaped thermoplastic polyester,
d) Recovering the 3D-printed object.

4. The production method according to claim 3, wherein in step b) the thermoplastic polyester is shaped like a thread, filament, rod, granules, pellets or powder.

5. The method according to claim 3, wherein the 3D printing step c) is carried out by the fused deposition modeling technique or by the selective laser sintering technique.

6. The use according to claim 1 wherein the 1.4:3.6-dianhydrohexitol (A) is isosorbide.

7. The use according to claim 1 wherein the polyester is free of alicyclic diol units or comprises a molar amount of alicyclic diol units, relative to the total of monomeric units in the polyester, of less than 1%, preferably the polyester is free of alicyclic diol units.

8. The use according to claim 7, wherein the polyester is free of 1.4-cyclohexanedimethanol, 1,2-cyclohexanedimethanol, 1,3-cyclohexanedimethanol or a mixture of these diols.

9. The use according to claim 1 wherein the molar ratio (3.6-dianhydrohexitol unit (A)+ethylene glycol unit (B))/(terephthalic acid unit (C)) is from 1.05 to 1.5.

10. The use according to claim 1 wherein the 3D-printed object comprises one or more additives.

11. The use according to claim 1, wherein the 3D-printed object comprises a polymeric mixture consisting of said thermoplastic polyester and one or more additional polymers, said mixture comprising at least 30% by weight of thermoplastic polyester with respect to the total weight of said mixture, preferably said one or more additional polymers being selected from polyesters, such as polybutylene terephthalate (PBT), polylactic acid (PLA), polybutylene succinate (PBS), polybutylene succinate adipate (PBSA), polyethylene terephthalate PET, glycolated polyethylene terephthalate (PETg), polycarbonates (PC), polyamide (PA), acrylonitrile butadiene styrene (ABS), thermoplastic polyurethane (TPU), polyetheretherketone (PEEK), polyacrylates.
